(19) United States
(12) Patent Application Publication
(10) Pub. No.: US 2020/0200299 A1
(43) Pub. Date: Jun. 25, 2020

(54) TUBULAR BODY AND METHOD FOR MANUFACTURING TUBULAR BODY

(71) Applicant: MIZUNO TECHNICS CORPORATION, Gifu-ken (JP)

(72) Inventors: Akira UNOSAWA, Gifu-ken (JP); Kanade KATAYAMA, Gifu-ken (JP)

(21) Appl. No.: 16/716,030

(22) Filed: Dec. 16, 2019

(30) Foreign Application Priority Data
Dec. 20, 2018 (JP) 2018-238282

(51) Int. Cl. F16L 9/16; F16L 9/12; B29C 53/56

(52) U.S. Cl. CPC F16L 9/16; B29K 2105/06; B29C 53/56; F16L 9/121

(57) ABSTRACT

A tubular body includes a fiber-reinforced resin layer including a prepreg sheet, which is made of fiber-reinforced resin, wound into a tubular shape and cured. The prepreg sheet includes an edge that is located at an end in a direction in which the prepreg sheet is wound. The fiber-reinforced resin layer includes a joining portion where the edge of the prepreg sheet is joined to the prepreg sheet. The joining portion extends helically over a single winding or more around the axis of the tubular body.

### BACKGROUND

### 1. Field

The present disclosure relates to a tubular body and a method for manufacturing a tubular body.

### 2. Description of Related Art

As described in Japanese Laid-Open Patent Publication No. 11-262545 and Japanese Laid-Open Patent Publication No. 2009-58184, tubular bodies made of fiber-reinforced resin are used for the shaft of a badminton racket or the shaft of an arrow for archery. The tubular bodies described in the publications are manufactured in the following manner. As shown in FIGS. 7A and 7B, a prepreg sheet 30, which is a sheet of a material prepared by impregnating reinforced fibers such as carbon fibers and glass fibers with a thermosetting resin, is wound around the outer circumference of a core 31 to form a tubular mold product. Then, the mold product is heated to cure the thermosetting resin. After the mold product is cooled, the core 31 is removed to obtain a tubular body 33.

As shown in FIG. 7A, the prepreg sheet 30 includes edges 30a at two ends in a winding direction. As shown in FIG. 7B, the tubular body 33, which is formed by curing the prepreg sheet 30 that is wound into a tubular shape, includes a joining portion 33a where the edges 30a of the prepreg sheet 30 are joined. The joining portion 33a results in uneven distribution of residual stress in the circumferential direction of the tubular body 33 and causes undesirable warping in the tubular body 33.

### SUMMARY

It is an objective of the present disclosure to reduce undesirable warping in a tubular body that is manufactured using a prepreg sheet.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a first general aspect, a tubular body includes a fiber-reinforced resin layer including a prepreg sheet, which is made of fiber-reinforced resin, wound into a tubular shape and cured. The prepreg sheet includes an edge that is located at an end in a direction in which the prepreg sheet is wound. The fiber-reinforced resin layer includes a joining portion where the edge of the prepreg sheet is joined to the prepreg sheet. The joining portion extends helically over a single winding or more around an axis of the tubular body.

In a second general aspect, a method for manufacturing a tubular body includes winding a prepreg sheet, which is made of fiber-reinforced resin, around an elongated core, and curing the prepreg sheet wound around the core. The prepreg sheet has a winding initiation edge and a winding termination edge that are respectively located at two ends in a direction in which the prepreg sheet is wound. The winding of a prepreg sheet includes winding the prepreg sheet around the core so that at least one of the winding initiation edge or the winding termination edge extends helically over a single winding or more around an axis of the core.

Other features and aspects will be apparent from the following detailed description, the drawings, and the claims.

### BRIEF DESCRIPTION OF THE DRAWINGS

FIG. 1 is a perspective view of a tubular body.

FIG. 2 is a cross-sectional view taken along line 2-2 in FIG. 1.

FIG. 3A is a cross-sectional view taken along line 3A-3A in FIG. 1.

FIG. 3B is an enlarged view showing the portion indicated by reference 3B in FIG. 3A.

FIG. 4A illustrates a method for manufacturing the tubular body.

FIG. 4B is an enlarged view showing the portion indicated by reference character 4B in FIG. 4A.

FIG. 4C illustrates a method for manufacturing the tubular body.

FIG. 4D illustrates a method for manufacturing the tubular body.

FIG. 5A is a side view showing a modification of the tubular body.

FIG. 5B is an enlarged view showing the portion indicated by reference character 5B in FIG. 5A.

FIG. 5C is an enlarged view showing the portion indicated by reference character 5C in FIG. 5A.

FIG. 6 is a cross-sectional view showing another modification of a mold product.

FIG. 7A illustrates a method for manufacturing a conventional tubular body.

FIG. 7B illustrates a method for manufacturing a conventional tubular body.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

One embodiment of the present disclosure will now be described below.

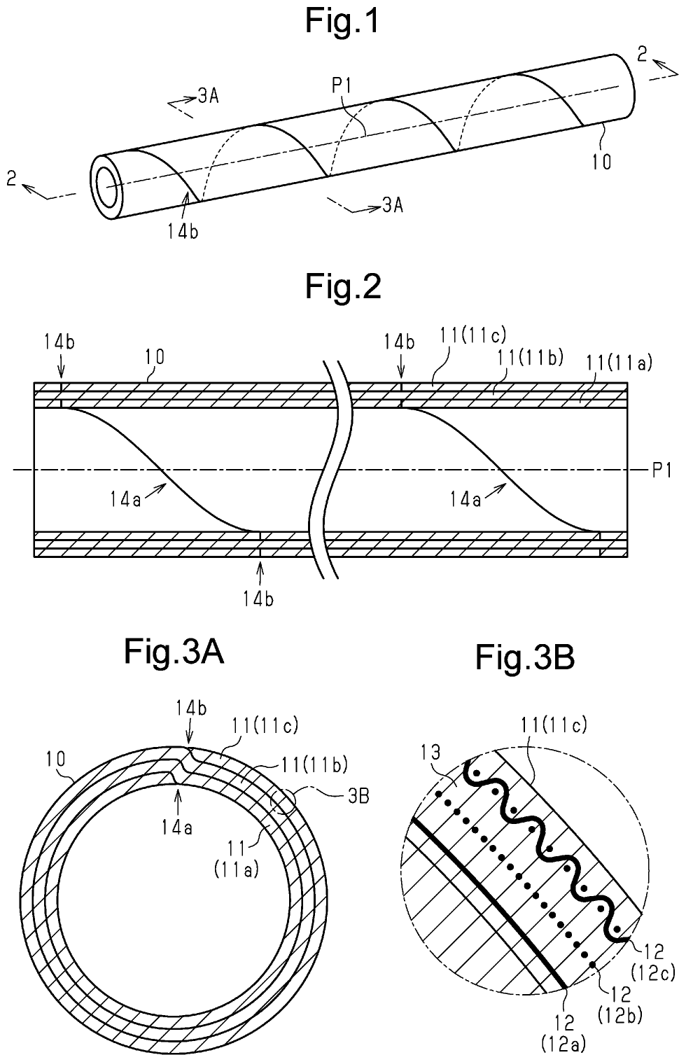

As shown in FIGS. 1 to 3A, a tubular body 10 is a cylindrical body made of fiber-reinforced resin in the form of a straight pipe and is used, for example, for the shaft of a badminton racket or the shaft of an arrow for archery. The dimensions of the tubular body 10 may be set in accordance with the application of the tubular body 10. The tubular body 10 has a thin wall and a small diameter. The tubular body 10 has, for example, a thickness of 0.5 to 5 mm and a ratio (L/D) of the axial length (L) to the diameter (D) is 50 to 200.

As shown in FIG. 3A, the tubular body 10 includes a three-layered fiber-reinforced resin layer 11. The three layers of the fiber-reinforced resin layer 11 will be referred to as an inner layer 11a, an intermediate layer 11b, and an outer layer 11c from the inner side in a radial direction.

Reinforced fibers 12 forming the fiber-reinforced resin layer 11 may be, for example, carbon fibers, glass fibers, any of various ceramic fibers, boron fibers, metal fibers, amorphous fibers, or organic fibers. The metal fibers are, for example, fibers made of copper or stainless steel. The organic fibers are, for example, fibers made of aromatic polyamide. The reinforced fibers 12 may include only one or more types of fibers.

The layout of the reinforced fibers 12 is not particularly limited. The reinforced fibers 12 may be laid out to extend in a specific direction or laid out in the form of a cloth or a woven fabric. Further, the reinforced fibers 12 may be laid out in different structures and overlapped in multiple layers. One example of the fiber-reinforced resin layer 11, which is shown in FIG. 3B, is a laminated structure of reinforced fibers 12a extending in the circumferential direction of the tubular body 10 and laid out next to one another in the axial direction of the tubular body 10, reinforced fibers 12b extending in the axial direction of the tubular body 10 and laid out next to one another in the circumferential direction of the tubular body 10, and reinforced fibers 12c laid out to form a cloth or a woven fabric.

A matrix resin 13 forming the fiber-reinforced resin layer 11 is a thermosetting resin selected from, for example, epoxy resin, phenol resin, polyester resin, vinyl ester resin, and unsaturated polyester resin. The matrix resin 13 may include only one or more types of resin.

The three-layered fiber-reinforced resin layer 11 is formed by winding a prepreg sheet, which is a sheet of a material prepared by impregnating reinforced fibers with synthetic resin, spirally in a cross-sectional view into a tubular shape and then curing the wound prepreg sheet. Adjacently arranged layers of the fiber-reinforced resin layer 11 are integrally joined. The prepreg sheet has a winding initiation edge and a winding termination edge that are respectively defined by the two ends in a winding direction. As shown in FIG. 3A, the inner layer 11a of the fiber-reinforced resin layer 11 located at the innermost side includes a first joining portion 14a where the winding initiation edge of the prepreg sheet is joined to the prepreg sheet. The outer layer 11c of the fiber-reinforced resin layer 11 located at the outermost side includes a second joining portion 14b where the winding termination edge of the prepreg sheet is joined to the prepreg sheet. In the example of FIG. 3A, the edges (winding initiation edge and winding termination edge) of the prepreg sheet are joined to portions of the prepreg sheet other than an edge.

As shown in FIGS. 1 and 2, each of the first joining portion 14a and the second joining portion 14b extends helically over a single winding or more around an axis P1 of the tubular body 10. Except in the extension over a single winding or more around the axis P1, the helical shapes of the first joining portion 14a and the second joining portion 14b may be set in accordance with various types of conditions such as dimensional accuracy or manufacturing efficiency that is required in accordance with the application. Each of the first joining portion 14a and the second joining portion 14b may extend helically over one to five windings around the axis P1. In particular, if the tubular body 10 is applied to the shaft of an arrow, each of the first joining portion 14a and the second joining portion 14b may extend helically over one to six windings around the axis P1. The first joining portion 14a and the second joining portion 14b may have the same or different helical shapes.

One example of a method for manufacturing a tubular body 10 will now be described.

The tubular body 10 is manufactured by performing a winding step for winding a prepreg sheet, which is made of fiber-reinforced resin, around a core and then a curing step for curing the prepreg sheet wound around the core.

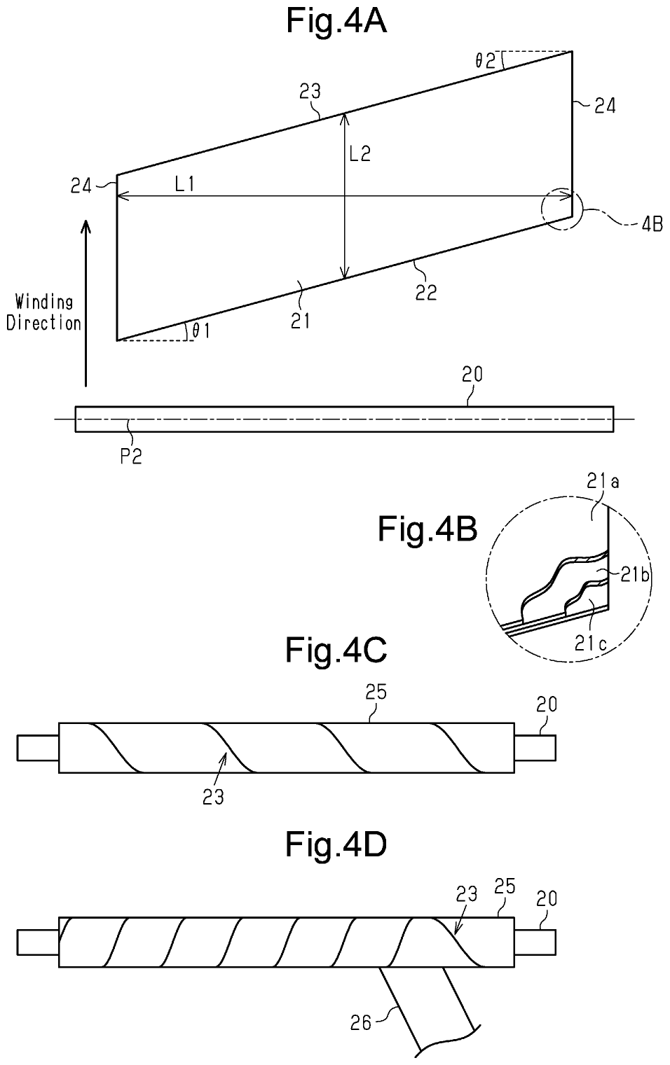

As shown in FIG. 4A, in the winding step, a prepreg sheet 21, which is a sheet of a material prepared by impregnating reinforced fibers with pre-cured thermosetting resin, is wound around the outer circumferential surface of an elongated core 20 so as to have a spiral cross section. The core 20 is an elongated cylindrical body and has a length that is greater than the axial length of the tubular body 10 to be manufactured. The prepreg sheet 21 is a parallelogram sheet having a winding initiation edge 22 and a winding termination edge 23 that are respectively defined by the two ends in the winding direction and extended in a direction inclined relative to an axis P2 of the core 20 and two side edges 24 that are arranged in parallel in the winding direction.

A lateral length L1 of the prepreg sheet 21 is set to be the same as the axial length of the tubular body 10 to be manufactured. A transverse length L2 of the prepreg sheet 21 is set based on the number of layers (three layers) of the fiber-reinforced resin layer 11 in the tubular body 10 to be manufactured.

Inclination angles Θ1, Θ2 of the winding initiation edge 22 and the winding termination edge 23 relative to the axis P2 are set based on the helical shapes of the first joining portion 14a and the second joining portion 14b of the tubular body 10 to be manufactured. The inclination angles Θ1, Θ2 may be, for example, more than or equal to three degrees. As the inclination angles Θ1, Θ2 increase, a pitch of a helix formed by the first joining portion 14a and the second joining portion 14b becomes shorter. The inclination angles Θ1, Θ2 may be, for example, less than or equal to ten degrees. As the inclination angles Θ1, Θ2 decrease, the amount of work necessary to wind the prepreg sheet 21 around the core 20 is reduced. This improves efficiency of the winding step.

There is particularly no limit to the layout of the reinforced fibers in the prepreg sheet 21. The prepreg sheet 21 may include a UD (unidirectional) prepreg sheet prepared by impregnating multiple reinforced fibers laid out extending in the same direction with thermosetting resin and/or a cloth prepreg sheet prepared by impregnating a cloth or a woven fabric of reinforced fibers with thermosetting resin.

The prepreg sheet 21 may include a stack of prepreg sheets. As shown in FIG. 4B, in the present embodiment, the prepreg sheet 21 used in the winding step includes a stack of three prepreg sheets, which include a UD prepreg sheet 21a in which the reinforced fibers are laid out to extend in the transverse direction (winding direction), a UD prepreg sheet 21b in which the reinforced fibers are laid out to extend in the lateral direction (direction of axis P2 of core 20), and a cloth prepreg sheet 21c.

As shown in FIG. 4C, the winding step is performed to obtain a mold product 25 in which the prepreg sheet 21 is wound into a tubular shape around the outer circumferential surface of the core 20. The winding initiation edge 22 of the prepreg sheet 21 is inclined relative to the axis P2 of the core 20 so that the winding initiation edge 22, which located in the inner circumferential surface (not shown) of the mold product 25, extends helically around the axis P2 of the core 20. In the same manner, the winding termination edge 23 of the prepreg sheet 21 is inclined relative to the axis P2 of the core 20 so that the winding termination edge 23, which is located in the outer circumferential surface of the mold product 25, extends helically around the axis P2 of the core 20.

As shown in FIG. 4D, in the curing step, a wrapping tape 26 is wound around the outer circumferential surface of the mold product 25. The wrapping tape 26 tightens and applies pressure to the mold product 25. The wrapping tape 26 is tensioned and wound around the outer circumferential surface on the mold product 25 several times while being shifted little by little in the longitudinal direction of the mold product 25.

Then, the mold product 25, to which pressure is applied by the wound wrapping tape 26, is heated in a furnace or the like. This cures the thermosetting resin of the prepreg sheet 21 and integrally joins the layers of the prepreg sheet 21, which is wound to have a spiral cross section. The heating temperature in the curing step can be set based on the curing temperature of the thermosetting resin in the prepreg sheet 21.

After the mold product 25 is cooled, the wrapping tape 26 and the core 20 are removed to obtain the tubular body 10.

The operation of the present embodiment will now be described.

The first joining portion 14a of the tubular body 10 where the winding initiation edge 22 of the prepreg sheet 21 is joined extends helically over a single winding or more around the axis P1 of the tubular body 10, and the first joining portion 14a extends over the entire tubular body 10 in the circumferential direction. In the same manner, the second joining portion 14b where the winding termination edge 23 of the prepreg sheet 21 is joined extend helically over a single winding or more around the axis P1 of the tubular body 10, and the second joining portion 14b extends over the entire tubular body 10 in the circumferential direction.

The first joining portion 14a and the second joining portion 14b is where there is a tendency of residual stress increasing after the curing step. However, the first joining portion 14a and the second joining portion 14b are spread out in the circumferential direction to uniformly distribute residual stress in the circumferential direction. This reduces undesirable warping of the tubular body 10 caused by the first joining portion 14a and the second joining portion 14b.

As an experimental example, the inclination angles Θ1, Θ2 of the winding initiation edge 22 and the winding termination edge 23 of the prepreg sheet 21 were set to three degrees and a thin tubular body 10 having a small diameter was manufactured in the form of a straight pipe through the above manufacturing method. Subsequent to curing, the warping amount of the tubular body 10, which is the difference between the maximum height and the minimum height of an axially central portion when rotated about the axis P1, was 0.45 mm. The manufactured tubular body 10 had a diameter of 8.0 mm, an axial length of 1050 mm, and a thickness of 0.7 mm. The helix formed by each of the first joining portion 14a and the second joining portion 14b included four windings. In contrast, with a tubular body having a known structure and manufactured in the same manner as the tubular body 10 of the experimental example except in that the inclination angles Θ1, Θ2 were set to 0, the warping amount was 1.45 mm.

The present embodiment achieves the following advantages.

(1) The tubular body 10 includes the fiber-reinforced resin layer 11 formed by winding the prepreg sheet 21, which is made of fiber-reinforced resin, into a tubular shape and subsequently curing the prepreg sheet 21. The prepreg sheet 21 has the edges (winding initiation edge 22 and winding termination edge 23) defined by the ends in the winding direction. The fiber-reinforced resin layer 11 has the joining portions (first joining portion 14a and second joining portion 14b) where the edges of the prepreg sheet 21 (winding initiation edge 22 and the winding termination edge 23) are joined to the prepreg sheet 21. Each of the joining portions (first joining portion 14a and the second joining portion 14b) extend helically over a single winding or more around the axis P1 of the tubular body 10.

The above structure reduces undesirable warping of the tubular body 10 caused by the joining portions.

Undesirable warping of the tubular body 10 caused by the joining portions may also be reduced by performing a correction process such as heat correction on the cured tubular body 10. In this case, however, the tubular body 10 may return to its original warped state over time. The above structure eliminates the need for a correction process and thus avoids a situation in which the tubular body 10 returns to a warped state subsequent to the correction process. Even if the correction process is performed, the amount of correction is reduced. Thus, the tubular body 10 is less likely to return to a warped state.

The joining portions extend helically so that the joining portions are not locally arranged in the circumferential direction of the tubular body 10. This uniformly distributes mass in the circumferential direction and reduces differences in the flexural strength of the tubular body 10 that is dependent on the bending direction.

(2) The outer layer 11c of the fiber-reinforced resin layer 11 located at the outermost side in the radial direction of the tubular body 10 includes the helically extended joining portion (second joining portion 14b).

Warping caused by the edges of the prepreg sheet 21 in the winding direction is more likely to occur at the edge located near the outer circumference of the tubular body 10. Thus, the helically extended joining portion arranged at the outermost side of the fiber-reinforced resin layer 11 increases the warping reducing effect.

(3) The fiber-reinforced resin layer 11 includes the prepreg sheet 21 wound to have a spiral cross section.

When the prepreg sheet 21 is wound to have a spiral cross section, a step is likely to be formed near the joining portions (first joining portion 14a and second joining portion 14b). This will increase biased residual stress and increase the tendency of warping to occur. In this regard, the helically extending joining portions (first joining portion 14a and second joining portion 14b) improves the warping reducing effect and easily increases productivity.

(4) The prepreg sheet 21 includes the cloth prepreg sheet 21c.

When a cloth prepreg sheet is used, the mechanical characteristics of the composite material (unidirectional material in particular), which is anisotropic, become isotropic. This further equally distributes residual stress. Thus, the use of the cloth prepreg sheet is advantageous for stability (warping reduction) of the tubular body 10. However, a typical cloth prepreg sheet is thick. If the fiber-reinforced resin layer 11 is formed by a cloth prepreg sheet wound into a tubular shape, large steps are likely to be formed by the joining portions (first joining portion 14a and second joining portion 14b). When the joining portions with large steps are arranged in a biased manner in the circumferential direction of the tubular body 10, the tubular body 10 will have a tendency to warp. This demerit will be greater than the advantage obtained by using the cloth prepreg sheet. In this respect, the helically extending joining portions overcome the demerit thereby allowing the advantage of the cloth prepreg sheet to be fully obtained.

(5) The dimensions of the tubular body 10 are set so that the thickness is 0.5 to 5 mm and the ratio (L/D) of the axial length (L) to the diameter (D) is 50 to 200.

Warping caused by the edges of the prepreg sheet 21 in the winding direction is more likely to occur as the tubular body 10 becomes thinner and the diameter of the tubular body 10 decreases. In this regard, the helically extending joining portions in the thin and tubular body 10 having a small diameter improve the warping reducing effect.

(6) A method for manufacturing the tubular body 10 includes the winding step for winding a prepreg sheet 21, which is made of fiber-reinforced resin, around an elongated core 20 and the curing step for curing the prepreg sheet 21 wound around the core 20. The prepreg sheet 21 has the winding initiation edge 22 and the winding termination edge 23 that are respectively defined by the two ends in the winding direction. The winding step includes winding the prepreg sheet 21 around the core 20 so that the winding initiation edge 22 and the winding termination edge 23 extend around the axis P2 of the core 20 over a single winding or more.

The above structure allows for manufacturing of the tubular body 10 that reduces undesirable warping.

The present embodiment may be modified as follows. The present embodiment and the following modifications can be combined as long as the combined modifications are not in contradiction.

The helical joining portion may partially include a portion that is not helical.

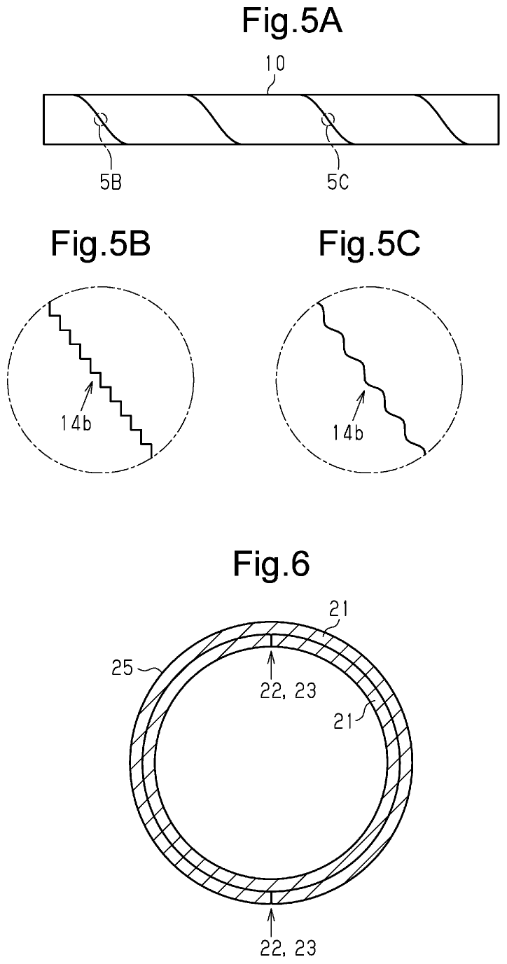

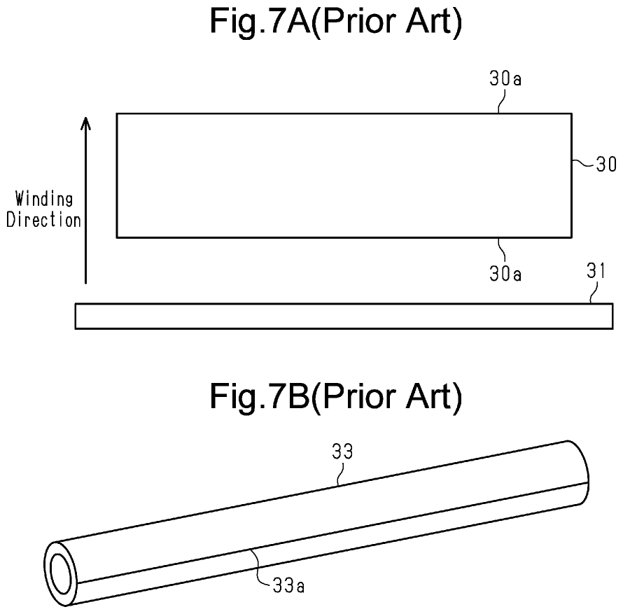

The helical joining portion in its entirety may helically extend over a single winding or more around the axis P1 of the tubular body 10. As shown in FIGS. 5A to 5C, the joining portion, specifically, the edge of the prepreg sheet 21, may be saw-tooth shaped or be shaped to be jagged or corrugated.

Only one of the winding initiation edge 22 and the winding termination edge 23 of the prepreg sheet 21 (namely, first joining portion 14a and second joining portion 14b) may be helically extended.

The number of layers in the fiber-reinforced resin layer 11 may be less than or equal to two or greater than or equal to four and is not limited in particular as long as there is one layer or more.

The shape of the fiber-reinforced resin layer 11, that is, the winding shape of the manufactured prepreg sheet 21 is not limited to the spiral cross section. The prepreg sheet 21 may be wound to have an annular cross section so that the winding initiation edge 22 and the winding termination edge 23 of the prepreg sheet 21 are joined to each other as in a mold product 25 shown in FIG. 6. Further, the tubular body may include layers of the fiber-reinforced resin layer 11 having an annular cross section. Alternatively, the tubular body may include both of the fiber-reinforced resin layer 11 that has a spiral cross section and the fiber-reinforced resin layer 11 that has an annular cross section. The “annular cross section” indicates a cross-sectional shape obtained by joining the two ends in the winding direction (two ends in circumferential direction) of the sheet body. In the example of FIG. 6, the joining portion is where the two edges (winding initiation edge and winding termination edge) of the prepreg sheet are joined.

The tubular body 10 is not limited to a cylindrical body of a straight pipe, specifically, a tubular body that has a circular cross section with a fixed diameter in the axial direction. The tubular body 10 may be, for example, a tubular body such as a tapered shape that has a varying diameter in the axial direction or a polygonal cylinder, specifically, a tubular body having a polygonal cross section.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A tubular body comprising:
a fiber-reinforced resin layer including a prepreg sheet, which is made of fiber-reinforced resin, wound into a tubular shape and cured, wherein
the prepreg sheet includes an edge that is located at an end in a direction in which the prepreg sheet is wound,
the fiber-reinforced resin layer includes a joining portion where the edge of the prepreg sheet is joined to the prepreg sheet, and
the joining portion extends helically over a single winding or more around an axis of the tubular body.

2. The tubular body according to claim 1, wherein
the fiber-reinforced resin layer includes a plurality of layers, and
at least one of the layers of the fiber-reinforced resin layer includes the joining portion, which extends helically.

3. The tubular body according to claim 2, wherein one of the layers of the fiber-reinforced resin layer located at an outermost side in a radial direction of the tubular body includes the joining portion, which extends helically.

4. The tubular body according to claim 1, wherein the fiber-reinforced resin layer includes the prepreg sheet wound to have a spiral cross section.

5. The tubular body according to claim 1, wherein the prepreg sheet includes a cloth prepreg sheet.

6. The tubular body according to claim 1, wherein the tubular body has a thickness of 0.5 to 5 mm and a ratio of an axial length of the tubular body to a diameter of the tubular body is 50 to 200:1.

7. The tubular body according to claim 1, wherein
the tubular body is applied to a shaft of an arrow, and
the joining portion extends helically over one to six windings around the axis of the tubular body.

8. A method for manufacturing a tubular body, the method comprising:
winding a prepreg sheet, which is made of fiber-reinforced resin, around an elongated core; and
curing the prepreg sheet wound around the core, wherein
the prepreg sheet has a winding initiation edge and a winding termination edge that are respectively located at two ends in a direction in which the prepreg sheet is wound, and
the winding of a prepreg sheet includes winding the prepreg sheet around the core so that at least one of the winding initiation edge or the winding termination edge extends helically over a single winding or more around an axis of the core.
